(19) United States
(12) Patent Application Publication
(10) Pub. No.: US 2024/0169804 A1
(43) Pub. Date: May 23, 2024

(54) Event interface for multiple events including at least one random event

(71) Applicants: Eran Eliyahu Tobul, Miami, FL (US); Ethan Noah Tobul, Miami, FL (US)

(72) Inventors: Eran Eliyahu Tobul, Miami, FL (US); Ethan Noah Tobul, Miami, FL (US)

(21) Appl. No.: 17/945,159

(22) Filed: Sep. 15, 2022

Related U.S. Application Data
(60) Provisional application No. 63/245,867, filed on Sep. 19, 2021.

(51) Int. Cl. G07F 17/32

(52) U.S. Cl. CPC G07F 17/3288; G07F 17/3267

(57) ABSTRACT

A system and method for an event interface for multiple events, such as a game of chance played with two or more events, including at least one random event and, more particularly, but not exclusively, a payout for one event and a multiplied payout if the one event also coincides with a second event, wherein at least one of the events occurs live. For example, betting on a roulette event may be combined with betting on another random event and/or a non-random event. The random event may include a verifiable physical event such as a physical roulette wheel. The events may include multiple physical roulette wheels.

### RELATED APPLICATIONS

This application claims the benefit of priority under 35 USC § 119(e) of U.S. Provisional Patent Application No.

63/245,867 filed 19 Sep. 2021, the contents of which are incorporated herein by reference in their entirety.

### FIELD AND BACKGROUND

The present invention, in some embodiments thereof, relates to relates to an event interface for multiple events, such as a game of chance played with two or more events, including at least one random event and, more particularly, but not exclusively, a payout for one event and a multiplied payout if the one event also coincides with a second event.

People are fascinated by games of chance, and there is a demand for such games which provide the possibility of higher winnings. For example, the website

https://tracksino.com/lightning-roulette/watch combines “lightening numbers” with a roulette wheel to provide higher value bets.

Many gamblers do not trust electronically generated games. Therefore, there is a need for a game of chance that offers the possibility of higher winnings while being trustworthy.

### SUMMARY

According to an aspect of some embodiments of the invention, there is provided a system for betting on at least two events including: a roulette event generator; a betting interface; an output interface displaying results of a first event and the roulette event generator; and a payout interface; wherein a payout for correctly betting on the first event is multiplied by correctly betting on the roulette event.

According to some embodiments of the invention, the first event includes a random physical event.

According to some embodiments of the invention, first event is presented electronically with at least one of a certification and a license.

According to some embodiments of the invention, at least one of the roulette events includes a physical roulette wheel.

According to some embodiments of the invention, the roulette event is presented electronically with at least one of a certification and a license.

According to some embodiments of the invention, the first event and the roulette event occur simultaneously.

According to some embodiments of the invention, the first event and the roulette event occur immediately one after the other.

According to some embodiments of the invention, the first event and the roulette event occur one after the other with a time interval between them.

According to some embodiments of the invention, further bets are placed during the time interval between the first event and the roulette event.

According to some embodiments of the invention, the at least one of the events occurs live.

According to some embodiments of the invention, the betting interface includes in person, online or both.

According to some embodiments of the invention, the betting interface includes a website and wherein the website and output interface are accessible over the Internet.

According to some embodiments of the invention, the betting interface is a slot machine.

According to some embodiments of the invention, the slot machine gives a fixed payout for a predetermined outcome from a plurality of physical roulette wheels. According to some embodiments of the invention, the betting interface is a slot machine.

According to some embodiments of the invention, the betting interface includes a dedicated server.

According to some embodiments of the invention, the betting interface is configured to receives bets from multiple players simultaneously.

According to some embodiments of the invention, multiple players place bets simultaneously in person, online or both.

According to some embodiments of the invention, a payout based on a likeliness of the first event and the roulette event occurring simultaneously.

According to some embodiments of the invention, a payout based on a likeliness of the roulette event and betting received on the first event.

According to some embodiments of the invention, the system includes multiple betting points.

According to some embodiments of the invention, a bet includes a single random event, multiple random events, or additional random events after seeing the results of a one or more initial random events.

According to some embodiments of the invention, a time for placing a bet is limited.

According to some embodiments of the invention, a certain number of bets must be placed within a limited time.

According to some embodiments of the invention, a payout includes correctly selecting the outcome of one or more random events.

According to some embodiments of the invention, a payout includes correctly selecting the outcome of two or more random events.

According to some embodiments of the invention, a payout includes correctly selecting the outcome of three or more random events.

According to some embodiments of the invention, a player's winnings are displayed, announced or both.

According to an aspect of some embodiments of the invention, there is provided a method for betting on at least two events including: receiving a bet on a compound result including a result of a first event and a result of a roulette event; setting payouts for a plurality of bets wherein a payout for a correct bet on a compound event includes betting correctly on a result of the first event and betting correctly on a result of the roulette event is greater than the payout for betting correctly on a result of the first event or the roulette event separately; performing the roulette event and the first event; revealing results of the roulette event and the first event; and paying out according to the results.

According to some embodiments of the invention, the performing includes spinning at least one physical roulette wheel.

According to some embodiments of the invention, the performing includes spinning at least two physical roulette wheels.

According to some embodiments of the invention, the method further includes supplying a slot machine interface and wherein the paying out includes a predetermined payout for a predetermined outcome of the at least two physical roulette wheels.

According to some embodiments of the invention, the method further includes at least one of certifying and licensing the spinning.

According to some embodiments of the invention, the method further includes at least one of certifying and licensing the spinning.

According to some embodiments of the invention, the performing includes performing the roulette event, first event or both live.

According to some embodiments of the invention, the performing the first event includes using a computer generating at least one random number.

According to some embodiments of the invention, the performing the first event includes a slot machine.

According to some embodiments of the invention, the performing the first event includes playing a sporting event, card game, or part thereof.

According to some embodiments of the invention, the first event and the roulette event occur simultaneously, immediately one after the other, or staggered one after the other with a time interval between them.

According to some embodiments of the invention, the method further includes: displaying at least one of odds of correctly betting on additional random events for obtaining a multiplier and payout for a bet.

According to some embodiments of the invention, the revealing includes displaying winnings for each random event and accumulated winnings over all bets.

According to some embodiments of the invention, the receiving a bet includes placing a bet through a betting interface.

According to some embodiments of the invention, the receiving a bet includes in person or online betting.

According to some embodiments of the invention, the receiving a bet occurs at multiple betting points.

According to some embodiments of the invention, the receiving a bet includes a single random event, multiple random events, or on additional random events after seeing the results of a one or more initial random events.

### SHORT DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practice.

In the figures:

FIG. 1: A flow diagram describing an in-person event in accordance with an embodiment of the current invention.

FIG. 2: A flow diagram describing an internet event in accordance with an embodiment of the current invention.

FIG. 3: A flow diagram describing an event in accordance with an embodiment of the current invention.

FIG. 4: A block diagram describing an event in accordance with an embodiment of the current invention.

FIG. 5: An exemplary image of a three roulette wheel betting event in accordance with an embodiment of the current invention.

FIG. 6: A block diagram describing an event interface in accordance with an embodiment of the current invention.

FIG. 7: A flow diagram describing an event interface including at least one random event in accordance with an embodiment of the current invention.

### DETAILED DESCRIPTION

The present invention, in some embodiments thereof, relates to relates to an event interface for multiple events, such as a game of chance played with two or more events, including at least one random event and, more particularly, but not exclusively, a payout for one event and a multiplied payout if the one event also coincides with a second event, wherein at least one of the events occurs live.

Overview

An aspect of some embodiments of the current invention relates to an event interface for multiple events, such as a game of chance using two or more events is disclosed and described. Optionally, the multiple events include at least one random event. In some embodiments, the random event includes a real physical event whose randomness is verifiable. For example, the random event may include a roulette wheel. Optionally, the event will be live. For example, player may be in the vicinity of the event and/or physically observe the event. Alternatively, the event may be live with local observers (e.g., a roulette wheel in a casino) and/or a player may receive a report from the live event (e.g., a live video showing the event and/or a result of the event). Optionally, the game will include more than one such random events. Optionally, the multiple events may include at least two random events.

In some embodiments, the multiple events include at least one random event and one non-random event (e.g., a sporting event, card game, etc. or part thereof). Optionally, the event interface provides a payout for one event and a multiplied payout if the one event also coincides with a second event. Optionally, at least one of the events occurs live. Optionally, the event interface may allow betting in-person in a casino, or casino-like setting. Optionally, the event interface may allow betting on line, e.g., on an internet gaming platform. Optionally, the appearance of the event interface on the internet gaming platform interface may be customized by the player. Optionally, the event interface may be added to an existing internet gaming platform and the appearance of the event interface may be customized by the owners of the existing internet gaming platform to fit in with their theme by a wide variety of designs, different shapes, sizes and/or colors. For example, the positioning of the results of one event may be displayed in the foreground, and the results of a second events may be displayed in the background and/or the payouts and/or odds may be displayed.

### Exemplary Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Some embodiments relate to an event interface for multiple events, such as a game of chance using two or more events. Optionally, the multiple events include at least one random event. Optionally, a random event may be verifiable and/or generated by an observable physical system. For example, multiple random events are coupled to produce a very low probability outcome. Optionally, the outcome of the random events verifiable independent of the betting and/or verifiable independent of the sponsor of the game. Optionally, players betting the low probably outcome receive a high payout. For example, the payout may be between 5 to 1 to 10 to 1 and/or between 10 to 1 to 30 to 1 and/or between 30 to 1 between 30 to 1 to 100 to 1 and/or between 100 to 1 to 10000 to 1.

Alternatively, and/or additionally, the multiple events may include at least one random event and one non-random event (e.g., a sporting event, card game, etc. or part thereof).

In an embodiment, the game provides a payout for one event and a multiplied payout if the first event also coincides with a second event. Alternatively, and/or additionally, in an embodiment the game provides a payout for one event and a multiplied payout if the first event also coincides with more than one additional event.

In an embodiment, at least one event is a roulette event e.g., spinning a physical roulette wheel and/or a simulated roulette wheel. In an embodiment, a roulette event may be combined with another event. Optionally, a roulette event may be combined with a first event and a second event. Optionally, a roulette event may be combined with multiple events. Optionally, these events may be random or non-random. Optionally, a roulette event may be combined with at least one additional roulette event, e.g., multiple physical roulette wheels. Optionally, a roulette event may be combined with at least one random event e.g., roulette wheel, slot machine, etc. Alternatively, and/or additionally, in an embodiment one or more events may be random selection of one or more cards from one or more decks of cards, draw of numbers from a bingo spinner, a wheel of fortune, etc. Optionally, a roulette event may be combined with at least one non-random event (e.g., a game of skill, a sporting event, a card game, horse race, election, football score, etc., or part thereof such as a single goal, single hand of cards, etc.).

As used herein, a “roulette event” refers to spinning a roulette event generator, such as a physical roulette wheel (e.g., an air roulette wheel and/or a conventional roulette wheel) and/or a simulated roulette wheel, etc. Optionally, results of the physical roulette wheel are presented live. Optionally the physical roulette wheel includes live observation. For example, a player may observe the wheel in person and/or there may be other players watching the wheel and/or a certification authority may be watching the wheel. In some embodiments, the player will watch a live video of the wheel and/or the observers. For example, a set of roulette physical roulette wheels in a casino may include in person players and bettors and remote bettors (for example, using an online and/or Internet betting interface and/or a slot machine interface [which may include for example, a slot machine interface in the casino, a slot machine interface in a separate gaming location and/or an Internet game)]). For the sake of this disclosure a slot machine interface is an interface wherein a player pays a bet to receive a set of multiple random symbols with a predetermined payout depending on the pattern of the symbols. For example, a slot machine based on three roulette events will present the roulette results and pay a predetermined payout for each possible combination of results of the roulette events.

In an embodiment, an event may include certification and/or a license. For example, certification and/or licensing may oversee the fairness of an event, the randomness of an event, the fairness of payouts and/or the honesty of statements about odd, betting, house advantages, payouts and/or events. For example, licensing may include from a legal jurisdiction for example, European jurisdictions like Malta, Gibraltar, and/or Alderney. Alternatively or additionally, a licensing body may include the United Kingdom Gambling Commission. Optionally, a certification authority and/or an auditing company may certify fairness of events (e.g., a physical roulette wheel). For example, auditing a certification authority and/or an auditing company may include iGaming Lab, eCogra, and Technical System Testing. For example, an authority may test whether events are random and/or fair, and/or published the results. For example, the certifier may test if the Return to Player (RTP percentages) are correct.

In some embodiments, the roulette event may include a modified roulette wheel, for example, there may be multiple balls and multiple numbers and/or the winning multiplier may be dependent of the number of balls e.g., the number of balls on the second wheel may itself be random. Alternatively, and/or additionally, in an embodiment the roulette wheel may choose multiple numbers and/or there may be different neighborhoods of the number that have different bonuses.

As used herein, the term “odds” refers to the probability of an event occurring.

As used herein, the term “payout” refers to how much a better receives for a successful bet. Optionally, the payout may be less than the odds, resulting in a house advantage. Optionally, the payout may be separate from odds e.g., payout may be determined based on the betting (e.g., higher payout for less chosen result such that the house advantage is that the combined payout for an event may be less than the combined betting against that event)

As used herein, the term “output interface” refers to an actual event e.g., a roulette wheel, screen display video of an event, screen display schematic of an event (e.g., display schematic of roulette wheel which lands on an electronically chosen random number), only a result (such as a display result (e.g., a number only) on computer screen or slot machine).

As used herein, the term “betting interface” refers to a means of placing a bet, e.g., in person in a casino, placing a bet on a roulette table, on-line through a digital interface, through a betting machine (e.g., a slot machine, etc.), or any other similar means.

As used herein, the term “betting point” refers to a point in a series of events wherein new bets will be received. For example, after of first event in a compound event, bets may be received with new odds and/or payouts for the compound event. Optionally, at some times during a game, betting will be open (e.g., betting points) and/or at some times in the game betting will be closed.

As used herein, the term “payout interface” refers to a means of receiving the results of betting. Optionally, the payout interface may be local such as chips in a casino, and/or remote (e.g., credit account on the Internet, BIT, PayPal, a banking app, etc.) and/or virtual (payout in money in metaverse).

In an embodiment, the event interface may provide a payout for one event and a multiplied payout if the one event also coincides with a second event. Optionally, at least one of the events occurs live e.g., a roulette event may include a broadcast and/or closed cast of a live roulette wheel and/or a real croupier. Optionally, the event interface may allow betting in-person in a casino, or casino-like setting. Optionally, the event interface may allow betting on line, e.g., on an internet gaming platform.

In an embodiment, the event may be played in-person in a casino or casino-like setting, such as a fun fair, fund raising event, etc. Alternatively, and/or additionally, in an embodiment the croupier of one roulette wheel may be aware or unaware of the second event, which may be run by a second croupier.

Additionally, and/or alternatively, the event may be performed over a network (e.g., the Internet). In an embodiment, the event may be performed on the internet, for example on an internet gaming platform. Optionally, results may be displayed on a display, announced and/or the results of several events may be woven together into an image. In some embodiments, information displayed and/or results displayed to a viewer on a network may be more than that known to the croupier and/or presenter.

In an embodiment, the roulette event may be played on the internet using one or more real roulette wheels.

In an embodiment, the event may be played on an internet gaming platform with one or more human croupiers who may select of one or more cards from one or more real decks of cards, draw one or more numbers from a real bingo spinner, spin a real wheel of fortune, use one or more real roulette wheels, etc.

In an embodiment, the event may be performed on the internet using two or more virtual random number generators.

In an embodiment, the appearance of the event interface on the internet may be customized by the player.

In an embodiment, the results of each event may be presented to the player or players on their computer screen/s and/or the results of the player's bets may be displayed even when the croupier does not yet know the combined result of multiple events.

In an embodiment, the event may be added to an existing internet gaming platform. Alternatively, and/or additionally, in an embodiment the appearance of the interface may be customized by owners of the existing internet gaming platform to fit in with their theme by a wide variety of designs, different shapes, sizes and/or colors.

In an embodiment, the event interface may be business to business, for example a business may add the event interface to its web site for a payment and/or a percentage of the profits accrued by the house and/or for a fee.

In an embodiment, one event may be displayed in foreground and/or while the second or more events may be displayed in the background and/or the potential winnings and/or odds may be displayed. Alternatively, and/or additionally, once the first event has a result, the focus may change to the second event, shifting the first event to the background, and the second event to the foreground, while the result of the first event may be maintained clearly visible. This process may be repeated for each subsequent event, and the results of each previous event may be clearly displayed along with the currently occurring event.

In an embodiment, there may be various displays of potential winnings and/or odds prior to each event, as the odds may change over time as each of the random numbers is fixed while some remain unknown.

In an embodiment, the payout for a first event may be 1) standard, or 2) may be reduced.

In an embodiment, the payout for a second event may be 1) standard, 2) one or more bonus amounts, 3) multiplied or added to the first event. Additionally, and/or alternatively, in an embodiment, additional events may be similarly paid out.

For example, if the player wins on the first event but not the second event, then the player may receive a reduced payment compared to standard roulette however, if the player wins the first event and the second event, then the player may receive significantly increased winnings. If the player then wins one or more additional events, then the player may receive even greater winnings.

In an embodiment, the player may pay a fee to buy in to play additional events beyond the first and second events.

In some embodiments, there may be a system to ensure fail play to bettors. For example, there may be an oversight authority and/or images may be live and/or a summary of winnings may be sent to users and/or a summary of bets may be sent to users.

In an embodiment, the odds of winning the event are clearly displayed.

In an embodiment, the results of the event are verifiably random.

In an embodiment, the event interface may include oversight of the randomness of the results, for example there may be security guards, cameras, other monitoring equipment to ensure that no tampering takes place.

In an embodiment, the results and/or bets may be published after each event and/or series of events to ensure transparency of the event interface.

In an embodiment, players may place bets up to a certain point and then the betting may be closed, and then the first event may take place, and may be followed by one or more additional events.

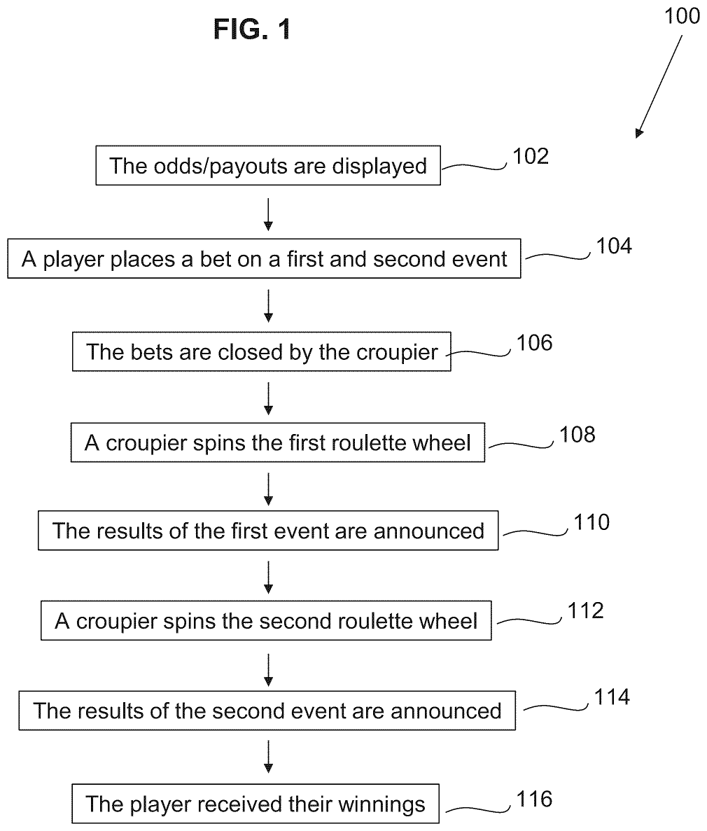

FIG. 1 shows a flow diagram describing an in-person event in accordance with an embodiment of the current invention. Optionally, more than one croupier may be used. Optionally, additional roulette wheels and/or multiple balls may be used. For example, in a game 100, the odds and/or payouts are displayed 102, a player places a bet on a first and second event 104 and/or one or more additional events. The bets are closed by a croupier 106 who then spins the first roulette wheel 108. The results of the first event are announced 110. The croupier spins the second roulette wheel 112. The results of the second event are announced 114, and so on. The player receives their winnings 116.

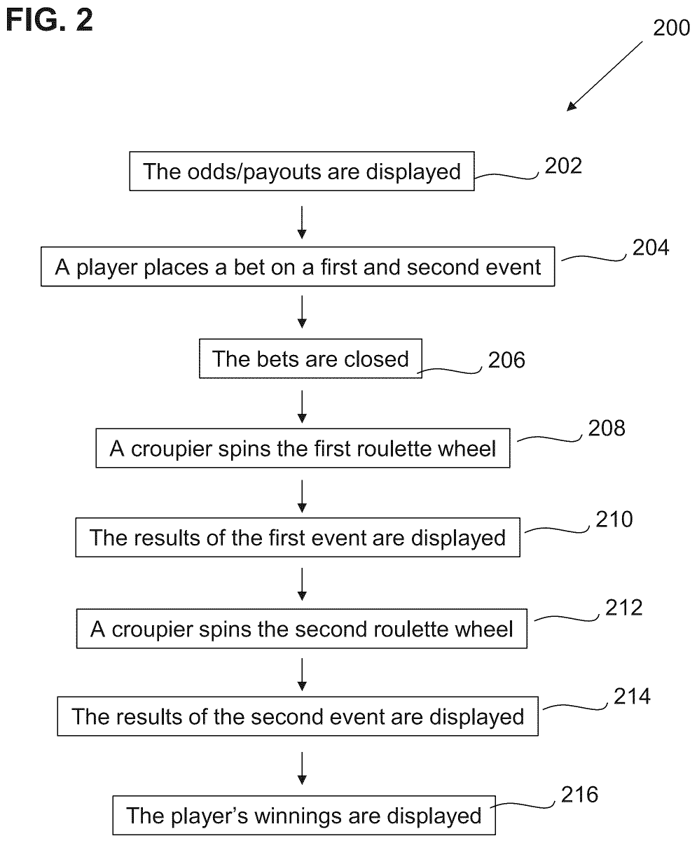

FIG. 2 shows a flow diagram describing an internet event in accordance with an embodiment of the current invention. Optionally, additional roulette wheels and/or multiple balls may be used. For example, in a game 200, the odds and/or payouts are displayed 202, a player places a bet on a first and second event 204 and/or one or more additional events. The bets are closed by a croupier 206 who then spins the first roulette wheel 208. The results of the first event are displayed 210. The croupier spins the second roulette wheel 212. The results of the second event are displayed 214, and so on. The player's winnings are displayed 216.

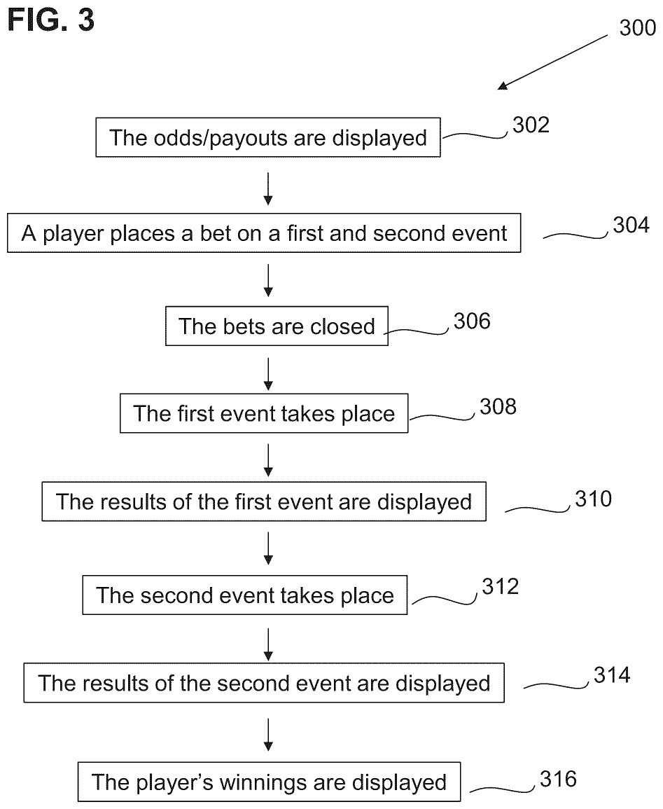

FIG. 3 shows a flow diagram describing an event in accordance with an embodiment of the current invention. For example, in a game 300, the odds and/or payouts are displayed 302, a player places a bet on a first and second event 304 and/or one or more additional events. The bets are closed 306. The first event takes place 308. The results of the first event are displayed 310. The second event takes place 312. The results of the second event are displayed 314, and so on. The player's winnings are displayed 316.

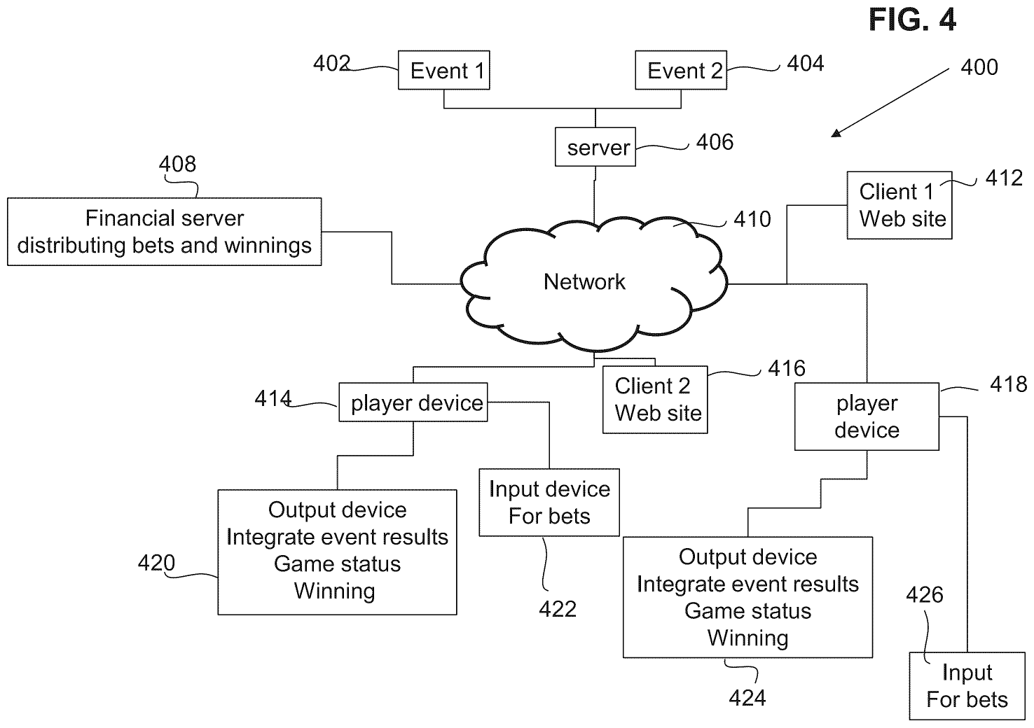

FIG. 4 shows a block diagram illustrates an event in accordance with an embodiment of the current invention. For example, for game 400, the results of Event 1 402 and the results of Event 2 404 are sent to server 406 which is connected to a network 410. The network 410 is also connected to a financial server distributing bets and winnings 408 and one or more client web servers 412, 416 and one or more player devices 414, 418 which are connected to an input device for placing bets 422, 426 and an output device which integrates event results, game status and winnings 420, 424.

Optionally, a live video may be made of event1 402 and/or event2 402. The videos are optionally sent live to player device 418. Optionally, the videos are verified and/or verifiable.

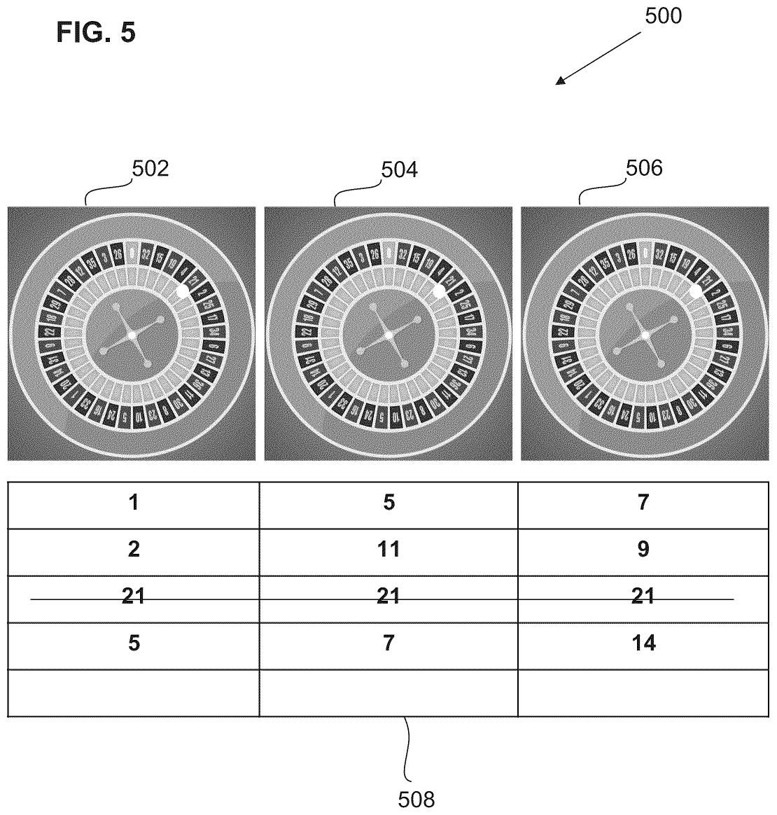

FIG. 5 shows a three roulette wheel betting event in accordance with an embodiment of the current invention. For example, a game 500 may be played in person in a casino and/or online. Multiple roulette wheels 502, 504 and 506 may be spun, and the results displayed on a score board 508.

In some embodiemnts, a slot machine type interface may allow a player to bet on two or more roulette wheels and/or see a video of those wheels as they are spun. Optionally, the game will be available on a machine in a casino and/or on a player machine over at network and/or over a remote machine at another site (for example a game arcade and/or a gambling arcade). For example, a player may make a bet (e.g., by inserting money or tokens into a machine and/or by on-line payment and/or by electronic payment to a machine). Optionally, one or more outcomes of the multiple roulette wheels will give a pre-determined pay-off. For example, if either wheel has a prespecified outcome, the player may receive a small payment and/or if multiple wheels have the same outcome there may be a larger payment and/or if all the wheels have a prespecified outcome there may be a mega-payment. For example, the small payment may range between 2 to 1 to 40 to one, the larger payment may range from 4 to 1 to 100 to 1 and/or the megapament may range between 40 to 1 to 10000 to 1.

In some embodiments, several physical roulette wheels (e.g., 2, 3, 4, 5, etc.) may be used in one event. Optionally, the roulette wheels may be activated at the same time, one after the other, at staggered intervals (e.g., the first wheel may be activated, then after 5 mins, the second may be activated, then after another 5 mins the third may be activated, etc.), in clusters, etc. Optionally, this may allow time for betting in between spinning each roulette wheel. Optionally, a bet may be placed on a single roulette wheel, or multiple wheels, or on additional wheels after seeing the results of a one or more initial bets. Optionally, a player may place a spot bet. Optionally, a player may place a high payoff bet. Optionally, a player may select a number to bet on, which if it appears on all the roulette wheels, e.g., all 3 roulette wheels, then it may pay off by several orders of magnitude, e.g., 10,000 times, 20,000 times, 30,000 times, 40,000 times, etc. the initial bet. Optionally, a player may bet that the same number will appear on all three roulette wheels without specifying what that number is for a bonus pay out, e.g., 1,000 times, 5,000 times or 10,000 times, etc. the initial bet. Optionally, a player may place a low payoff bet, e.g., one of three wheels may be a specific number and two other wheels may be a different but identical number without specifying the number. Optionally, a player may place a mega payoff bet e.g., bets on unlikely events of two or more roulette wheels, such as two of three roulette wheels will be the same number, all three roulette wheels will be the same number. For example, the user interface may be similar to a slot machine wherein the numbers are generated by a roulette wheel and/or the roulette wheel is presented live to the user.

In some embodiments, there may be a time limit to place a bet. Optionally, in order to continue playing a certain number of bets must be placed within a set time. Optionally, bets must be placed on all the wheels simultaneously in order to be valid. Optionally, every minute a player may place bets on all 3 roulette wheels simultaneously, which may increase a player's adrenaline, and/or enjoyment of the game.

In some embodiments, there may be multiple betting points e.g., place bets prior to spinning the first roulette wheel, then allow further bets, then spin the second roulette wheel.

In some embodiments, a player may be physically present in a casino at a roulette table, in a casino at a slot machine which may be connected to the roulette wheel (e.g., it may have an additional optionally window for the roulette wheel, which a player may choose to include in their bet, and which may provide an increased payout), online at a remote location with the casino, online at a betting parlor and/or online in a private location. Optionally, the roulette wheel may have symbols similar to a slot machine instead of numbers. Optionally, a slot machine may have one or more extra windows linked to one or more roulette wheels without the normal numbers etc. (e.g., the fourth number on a slot machine may be a graphic from the roulette wheel). Optionally, a slot machine may interface with a physical roulette wheel. Optionally, an online player may interface over the internet with a physical roulette wheel, slot machine and/or a combination thereof.

In some embodiments, player may place bets on a combination of events which may be random and/or games of skill (e.g., roulette and the results of a football match, horse race, slot machine, scoring a goal or points in various sports games, etc.) Optionally, a roulette wheel spin may be combined with another game, betting mode and/or event.

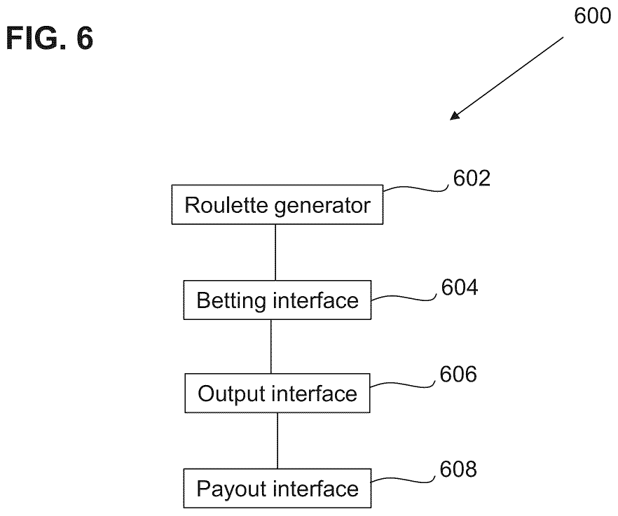

FIG. 6 is a block diagram describing an event interface in accordance with an embodiment of the current invention. For example, the event interface 600 may include a roulette generator 602, a betting interface 604, an output interface 606 and a payout interface 608. Optionally, these may be physical, digital or a combination thereof. Optionally, the interfaces may be part of a GUI. Optionally, the GUI may be customized by the user.

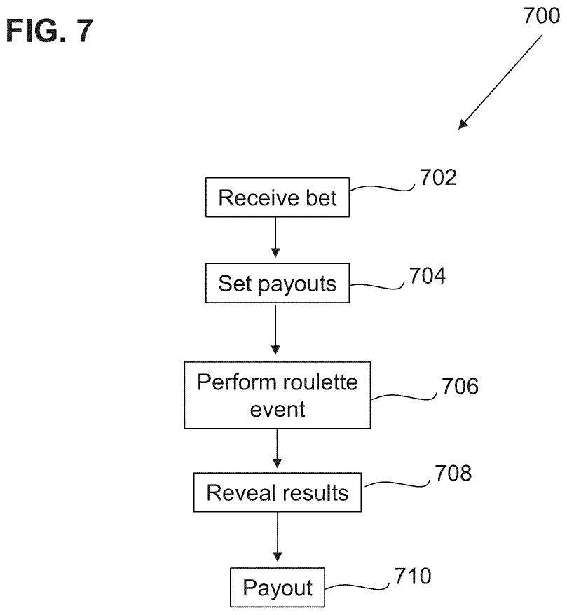

FIG. 7 is a flow diagram describing an event interface including at least one random event in accordance with an embodiment of the current invention. For example, the betting process 700 may be performed as follows: a bet is received 702, a payout is set 704. Optionally, a payout may be set based on the odds of an event. Alternatively or additionally, the payout may be based on the betting. Payouts may optionally be set 704 before betting (e.g., based on odds that are known before betting). Alternatively or additionally, payouts may be set 704 after betting (e.g., based on betting). Alternatively or additionally, preliminary payouts may be set and/or adjusted before, during and/or after betting. The roulette event is performed 706 and the results are revealed 708, and paid out 710 accordingly.

Some embodiments relate to a system for betting on at least two events including a roulette event generator (e.g., a physical roulette wheel, etc.), a betting interface (e.g., for placing a bet, which may be in-person, digital, or both), an output interface (e.g., displaying the results of said events, a player's winnings of said events, a player's overall winnings, etc.), and a payout interface. Optionally, the payout for correctly betting on said least two events is the payout for a single event multiplied by the probability of the second event possibly modified by adding a house advantage and/or a compensation for dependence between outcomes. Optionally, the at least two events may occur simultaneously, immediately one after the other or staggered (e.g., one after the other with a time interval between them to allow further bets to be placed during the time interval between the at least two events). Optionally, at least one of the events may occur live.

In some embodiments, a betting interface may be in person, online or both. Optionally, a betting interface may be a website. Optionally, the website and/or output interface may be accessible over the Internet. Optionally, the betting interface may be a slot machine. Optionally, the betting interface may be a dedicated server. Optionally, the betting interface may be configured to receives bets from multiple players simultaneously. Optionally, the multiple players may place bets simultaneously in person, online or both.

In some embodiments, a payout multiplier may increase based on the unlikeliness of the at least two events occurring. In some embodiments, the payout may be based on the betting (e.g., payouts are balanced to result in a house advantage for every outcome and/or a higher payout for outcomes having less bets. Optionally, at least one of the events may be a random event. Optionally, the time to place a bet may be limited. Optionally, a certain number of bets must be placed within a limited time.

In some embodiments, the system may include multiple betting points. Optionally, a bet may include be made on a single random event, multiple random events, or additional random events after seeing the results of a one or more initial random events. Optionally, a payout may be received for correctly selecting the outcome of one or more random events. Optionally, a payout may be received for correctly selecting the outcome of two or more random events and/or a random event along with a non-random event. Optionally, a payout may be received for correctly selecting the outcome of three or more random events. Optionally, a payout may be received for correctly selecting a compound result (e.g., two or more correctly selected events, etc.).

Some embodiments relate to a method for betting on at least two events including receiving a bet on a compound result, such as a result of a first event and a result of a random event (e.g., a roulette event, etc.). Optionally, payouts for a plurality of bets may be set wherein a payout for a correct bet on a compound event may be greater than the payout for betting correctly on a result of a first event or a random event separately. Optionally, performing said random event and said first event, revealing their results, and paying out according to said results.

In some embodiments, the performing said events may be performing the roulette event and/or first event live. Optionally, the performing the first event may include using a computer to generate at least one random number. Optionally, the performing the first event may include spinning at least one physical roulette wheel and/or a slot machine, playing a sporting event, card game, or part thereof. Optionally, the performing of at least two events may occur simultaneously, immediately one after the other, and/or staggered one after the other with a time interval between them.

In some embodiments, the odds of correctly betting on additional random events for obtaining the multiplier may be displayed. Optionally, the winnings for each event and/or accumulated winnings over all a player's bets may be displayed.

In some embodiments, a bet may be received by placing a bet through a betting interface. Optionally, a bet may be placed in person and/or online. Optionally, a bet may be placed at multiple betting points. Optionally, a bet may be placed on a single random event, multiple random events, and/or on additional random events after seeing the results of a one or more initial random events.

These embodiments are provided by way of example and are in no means intended to be limiting the scope of the invention.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

General

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

It is expected that during the life of a patent maturing from this application many relevant building technologies, artificial intelligence methodologies, computer user interfaces, image capture devices will be developed and the scope of the terms for design elements, analysis routines, user devices is intended to include all such new technologies a priori.

Unless otherwise defined, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for betting on at least two events comprising:
a roulette event generator;
a betting interface;
an output interface displaying results of a first event and said roulette event generator; and
a payout interface;
wherein a payout for correctly betting on said first event is multiplied by correctly betting on a roulette event of said roulette event generator.

2. The system of claim 1, wherein the first event includes a random physical event.

3. The system of claim 2, wherein first event is presented electronically with at least one of a certification and a license.

4. The system of claim 3, wherein at least one of the roulette events includes a physical roulette wheel.

5. The system of claim 4, wherein the roulette event is presented electronically with at least one of a certification and a license.

6. The system of claim 3, wherein the first event and the roulette event occur live.

7. The system of claim 3, wherein the betting interface includes both in person and online betting.

8. The system of claim 3, wherein the betting interface includes a website and wherein said website and output interface are accessible over the Internet.

9. The system of claim 3, wherein the betting interface includes a slot machine interface which gives a fixed payout for a predetermined outcome from a plurality of physical roulette wheels.

10. The system of claim 3, wherein a payout based on a likeliness of the first event and said roulette event occurring simultaneously.

11. The system of claim 3, wherein a time for placing a bet is limited.

12. The system of claim 3, wherein a payout includes correctly selecting an outcome of two or more random events.

13. A method for betting on at least two events comprising:
receiving a bet on a compound result including a result of a first event and a result of a roulette event;
setting payouts for a plurality of bets wherein a payout for a correct bet on a compound event includes betting correctly on a result of the first event and betting correctly on a result of the roulette event is greater than the payout for betting correctly on a result of said first event or said roulette event separately;
performing said roulette event and said first event;
revealing results of the roulette event and the first event; and
paying out according to said results.

14. The method of claim 13, wherein the performing includes spinning at least two physical roulette wheels.

15. The method of claim 14, further comprising supplying a slot machine interface and wherein said paying out includes a predetermined payout for a predetermined outcome of said at least two physical roulette wheels.

16. The method of claim 14, further including at least one of certifying and licensing said spinning.

17. The method of claim 14, wherein the performing includes performing the roulette event, the first event or both live.

18. The method of claim 14, wherein the first event and the roulette event occur simultaneously, immediately one after the other, or staggered one after the other with a time interval between them.

19. The method of claim 14, wherein the receiving a bet includes in person and remote betting.

20. The method of claim 14, wherein the receiving a bet includes a single random event, multiple random events, or on additional random events after seeing the results of a one or more initial random events.
